(19) United States
(12) Patent Application Publication
(10) Pub. No.: US 2014/0188542 A1
(43) Pub. Date: Jul. 3, 2014

(54) Methods and Systems for Determining, Characterizing, Addressing and Quantifying Disturbances to Transit System Operation

(71) Applicant: TRAPEZE SOFTWARE INC., Mississauga (CA)

(72) Inventors: Moru NUHAMOVICI, Thornhill (CA); Jarrod CLARK, Burlington (CA); Leonard ANGHELESCU, Toronto (CA)

(73) Assignee: TRAPEZE SOFTWARE INC., Mississauga (CA)

(21) Appl. No.: 13/727,720

(22) Filed: Dec. 27, 2012

(51) Int. Cl. G06Q 10/06

(52) U.S. Cl. CPC G06Q 10/06314
USPC 705/7.24

(57) ABSTRACT

A method and system for handling an incident affecting a transit agency is provided. The method and system allow for obtaining an indication of the existence of the incident, defining the incident, determining affected items, and securing the affected items as required. The method and system further allow for quantifying the impact of the incident.

### FIELD OF THE INVENTION

The present invention relates generally to handling emergency and other situations or incidents impacting normal transit system operation. More particularly, the present invention relates to systems and methods for characterizing emergency situations, identifying affected resources or items, and altering reliant-systems' actions responsive to such emergency situations.

### BACKGROUND OF THE INVENTION

Emergency situations or non-standard incidents, while not necessarily becoming more prevalent, are becoming more difficult to deal with as a result of the increased complexity of today's world. More and more people, technologies, processes, events and systems are interconnected and can be affected in diverse ways.

With respect to public transit, dealing with emergency situations, or incidents affecting normal operation, can be difficult to determine, manage, and quantify. Many approaches to dealing with these occurrences involve manual adjustments to schedules, human-driven determinations of who and what might be affected based on an estimation of the nature of the disruption, and post-event manual assessments of the impact. These approaches are both inaccurate, resulting in possible mishandling of events and calculation of impacts, but also time-consuming, which is not desirable in addressing events or in quantifying impact as an agency is trying to return to normal operation.

It is therefore an object of the invention to provide a novel method and system for determining, characterizing, addressing and quantifying disturbances to transit system operation.

### SUMMARY OF THE INVENTION

In a first aspect there is a system for handling an incident affecting a transit agency, the system having an operator from the transit agency, and the transit agency having one or more items, some of the items having a home location, that the transit agency may create a schedule for or have a current schedule for, the current schedule having a starting point, an ending point, and one or more route segments that define portions of streets being traveled on, the system comprising an incident module configured for obtaining an indication of the existence of the incident, defining the incident, providing the incident to a scheduling module, and a scheduling module further comprising a scheduling algorithm for creating schedules for items, the scheduling module configured for, ingesting the incident; and determining items affected by the incident.

The defining may further comprise receiving one or more geographic parameters relating to the incident, defining an incident geographical area (IGA) relating to the incident; and, accepting one or more parameters relating to the incident.

The receiving may further comprise presenting a screen to the operator, and the operator entering the one or more geographic parameters via the screen.

The geographic parameters may be three or more polygon points, selected by the operator on a map on the screen, and the defining further may further comprise using the three or more points to define a polygon that is the IGA. The geographic parameters may be an epicenter, selected by the operator on a map on the screen, and a radial distance selected by the operator, and wherein the defining further comprises using the point and radial distance to define a circle that is the IGA.

The determining may further comprise checking if an item's home location is within the IGA, if an item is currently within the IGA, or if the item's current schedule is to bring them into the IGA. The checking may further comprise comparing a home location GPS to the GPS area of the IGA, the current GPS location of the item to the GPS area of the IGA and comparing the GPS locations of the item's current schedule to the GPS area of the IGA. The checking further comprises using an interior point determination algorithm.

The incident module may further be configured for securing affected items and the securing may further comprise, if an item's home location is within the IGA then confirming if the item is at its home location and creating a current schedule to extract the item from the IGA, if an item is currently within the IGA, then creating a current schedule to extract the item from the IGA, and if the item's current schedule is to bring them into the IGA, then adjusting the current schedule to avoid the IGA.

The adjusting may further comprise using a single insertion batch scheduling algorithm for creating a current schedule or adjusting a current schedule.

The adjusting may further comprise marking the route for re-scheduling, reducing one or more allowable speeds on one or more route segments on the current schedule to disincent the scheduling module from selecting such one or more route segments, and re-scheduling the route according to the scheduling module's scheduling algorithm.

The creating may further comprise setting a starting point and ending point, calculating one or more routes for the starting point and ending point, reducing one or more allowable speeds on one or more route segments on the current schedule to disincent the scheduling module from selecting such one or more route segments, and selecting the route according to the scheduling module's scheduling algorithm.

The incident module may be further configured for calculating a cost to secure each item that is affected.

In a further aspect there is a system for defining an incident affecting a transit system having one or more items and a current schedule for each of the items, the system comprising, an incident module configured for, receiving one or more geographic parameters relating to the incident, defining an incident geographical area (IGA) relating to the incident, and accepting one or more incident parameters relating to the incident.

The receiving may further comprise presenting a screen to the operator, and the operator entering the one or more geographic parameters via the screen.

The geographic parameters may be three or more polygon points, selected by the operator on a map on the screen, and the defining may further comprise using the three or more points to define a polygon that is the IGA. The geographic parameters may comprise an epicenter, selected by the operator on a map on the screen, and a radial distance selected by the operator, and the defining may further comprise using the point and radial distance to define a circle that is the IGA.

The accepting may further comprises presenting a screen to the operator, and the operator entering the incident parameters via the screen. The entering may further comprise selecting an incident template from a list of incident templates available for selection via the screen.

In yet a further aspect there is a system for quantifying the impacts of an incident affecting a transit agency, the system having an operator from the transit agency, and the transit agency having one or more items, some of the items having a home location, that the transit agency may create a schedule for or have a current schedule for, the current schedule having a starting point, an ending point, and one or more route segments that define portions of streets being traveled on, the system comprising a scheduling module further comprising a scheduling algorithm for creating schedules for items, the scheduling module configured for ingesting the incident, determining items affected by the incident, securing items affected by the incident, computing a cost to secure items affected by the incident, and calculating the impact of the incident.

The determining may further comprise checking if an item's home location is within the IGA, if an item is currently within the IGA, or if the item's current schedule is to bring them into the IGA.

The securing may further comprise if an item's home location is within the IGA then confirming if the item is at its home location and creating a current schedule to extract the item from the IGA, if an item is currently within the IGA, then creating a current schedule to extract the item from the IGA, and, if the item's current schedule is to bring them into the IGA, then adjusting the current schedule to avoid the IGA.

The computing may further comprise, for each item that requires a current schedule to extract the item from the IGA, computing the cost of the schedule, and, for each item that requires a current schedule to be adjusted, computing the cost of the adjustment to the current schedule. The cost may further comprise driver salary and fuel. The calculating may further comprise summing all computed costs and one or more non-route costs relating to the incident.

### BRIEF DESCRIPTION OF THE DRAWINGS

Embodiments will now be described, by way of example only, with reference to the attached Figures, wherein:

FIG. 1 shows a system for handling incidents in transit system environments in accordance with an embodiment of the invention and its operating environment;

FIG. 2 shows a method of handling transit-effecting emergencies according to an embodiment of the present invention;

FIG. 3 shows a diagram of a screenshot depicting methods of specifying IGAs;

FIG. 4 shows a diagram of a screenshot depicting creation of an incident;

FIG. 5 shows a method of determining which items are affected by an incident;

FIG. 6 shows a diagram of possible transportation requirements during an incident, occurring outside the incident's geographical area;

FIGS. 7A and 7B show a diagram of a screenshot for creation transportation requests during an incident; and

FIGS. 8A and 8B show a diagram of possible transportation requirements during an incident, occurring outside the incident's geographical area.

### DETAILED DESCRIPTION OF THE EMBODIMENTS

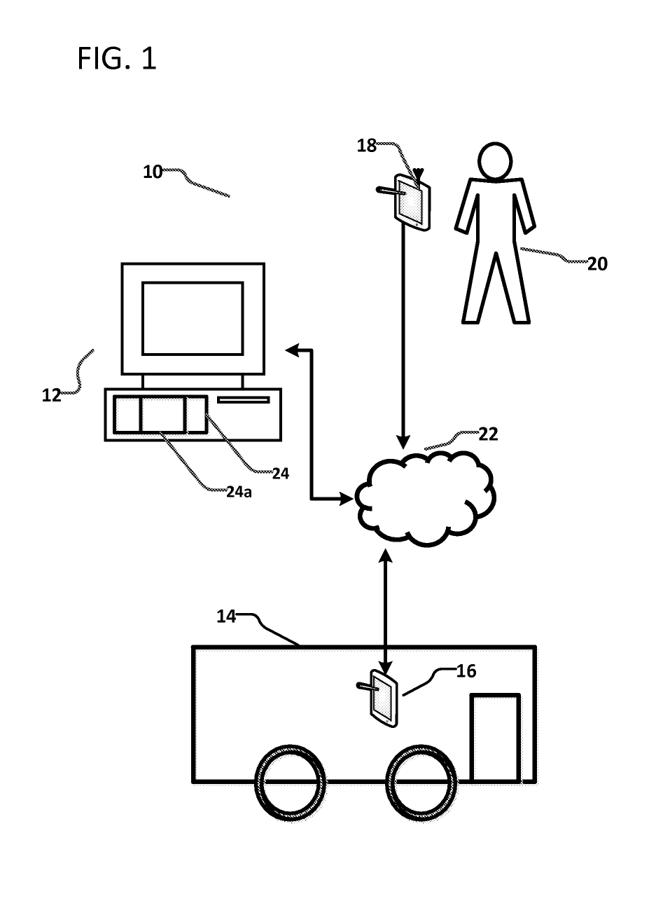

FIG. 1 shows a system 10 for handling incidents in a transit system comprising TIV 14, further comprising mobile data terminal (MDT) 16, communication network 22, transit control center (“TCC”) 12 which may further comprise transit software 24, which may comprise emergency/incident module 24a, TIV 14 monitoring, data analysis, optimization, bookings, and the like, rider 20 and rider communication device (RCD) 18.

TIV 14 is a vehicle that provides, or relates to the provision of, transit services. TIV 14 may include buses, para-transit vehicles, maintenance vehicles, supervisory vehicles (such as cars or vans driven by supervisors) or a light rail/TRAM vehicles. TIV 14 has many systems running thereon, as typical of vehicles, and also has MDT 16 thereon, though possibly being removable therefrom. MDT 16 may be used by a driver of TIV 14 to perform various functions relating to the provision of transit services (such as route direction, stop announcements, fare collection, system monitoring, door operation, confirm no-shows, assist in dynamic decisioning of how to secure items and update software 24 of such decisioning, creation of incidents such as by identifying an incident based on MTD's 16 position, and the like). MDT 16 may be substantially as known in the art and may be substantially similar to MDTs offered with Trapeze's transportation software (such as demand-response, paratransit, and the like). MDT 16 may communicate, via communication network 22, with transit control center 12 and rider communication device 18.

Transit control center 12 may be a system for operating one or more transit services, implemented via one or more software components, and may be used by one or more transit agencies. Transit control center 12 may further comprise transit software 24, which may comprise emergency module 24a, and other modules (not shown) for route generation, real-time location of vehicles, next bus prediction, driver assignments, TIV 14 monitoring, data analysis, optimization, bookings, and the like. One exemplary transit control center 12, and transit software 24 may be Trapeze's “Trapeze 12” product, which may include or communicate with emergency module 24a. Transit control center 12 may communicate, via communication network 22, with TIV 14 and rider communication device 18, as needed, to implement a transit system and the functionality required. In normal operation (ie when there is no active incident), incident module 24a may not impact operation of transit software 24—driver assignments, routes, next bus announcements, and the like, functioning normally. When there is an active incident, incident module 24a may operate with transit software 24 to provide the functionality described herein. For example, incident module 24a may be used to set a “possible speed” attribute for a particular street segment. That speed, for that street segment, may be used by transit software 24 to determine routes to be driven during the incident. Of course many such interactions are considered within the scope of embodiments of the present invention, as are many delineations of the areas of responsibility between transit software 24 and incident module 24a.

MDT 16 and RCD 18 may be computing devices that may take user input (such as keystrokes, clicks, touch inputs, and the like) and provides the user interface to functionality relating to the provision of transit services, and interacting with TCC and the software located thereon (such as transit software 24 and incident module 24a). Exemplary MDTs 22 and RCDs 18 include mobile phones, tablets, laptops (that may be running Windows™ or iOS™ operating systems, for example), ruggedized laptops, vendor specific devices (such as Android™. Blackberry™ or Apple™ products).

Communication network 22 may be substantially any public or private network, wired or wireless, and may be substantially comprised of one or more networks that may be able to facilitate communication between themselves.

Rider 20 may be substantially any person, client, customer, or entity using one or more of the transit services being offered by the transit agency that is using transit system 12. Rider 20 may, or may not, have an RCD 18 to interact with aspects of system 10

System 10 may be used to respond to emergency situations or disruptions that may affect one or more of transit services, clients of the transit agency, other assets of the transit agency, or assets being monitored by the transit agency (all such categories being “items” or “affected items” to ensure are properly taken care of during an emergency or disruption).

“Emergencies”, “incidents” or “disruptions” may be categorized as:
A general service disruption (“GSD”), which may significantly affect regular operation of transit, making the affected area either temporarily unusable or severely compromised. GSDs require transit vehicles to avoid the interference zones. Examples include: major traffic accidents, road closures, protests/rallies, parades and planned events.
A localized emergency (“LE”), which may require evacuation or avoidance from a neighborhood to elsewhere within the service area. Examples may include: toxic gas leak from a rail car or plant, broken water main, widespread or suspicious power outage, bomb threat, tornado.
A regional emergency (“RE”), which may affect the entire service area and are the most serious. Examples may include: hurricane, earthquake, volcano eruption, major terrorist attack, homeland security advisory.

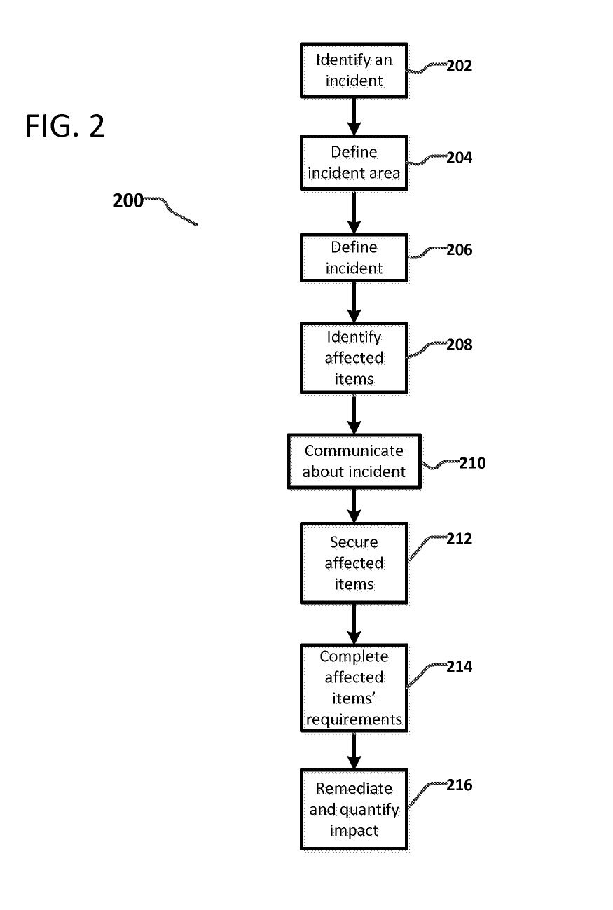

FIG. 2 shows the method 200 of handling transit-effecting emergencies according to an embodiment of the present invention. Method 200 may be largely implemented using aspects of system 10, for example with TCC 12 (and transit software 24 or incident module 24a) and external sources (not shown) that may be used to identify an incident and/or define an IGA.

Method 200 begins at 202 where an incident is identified. Identification may occur in any number of ways, provided that the result is that the transit agency and system 10 become aware of the incident. Exemplary ways of identification include:
one or members of a transit agency monitoring weather patterns;
news reports or feeds of current events, weather, and the like, for example identifying a gas leak at a particular street address;
rider 20 or drivers of TIV 14 providing information, for example via rider communication device 18, MDT 16 (such as by TIV 14 operator, who may be using MDT 16, observing or learning of an incident), phones, or other ways.

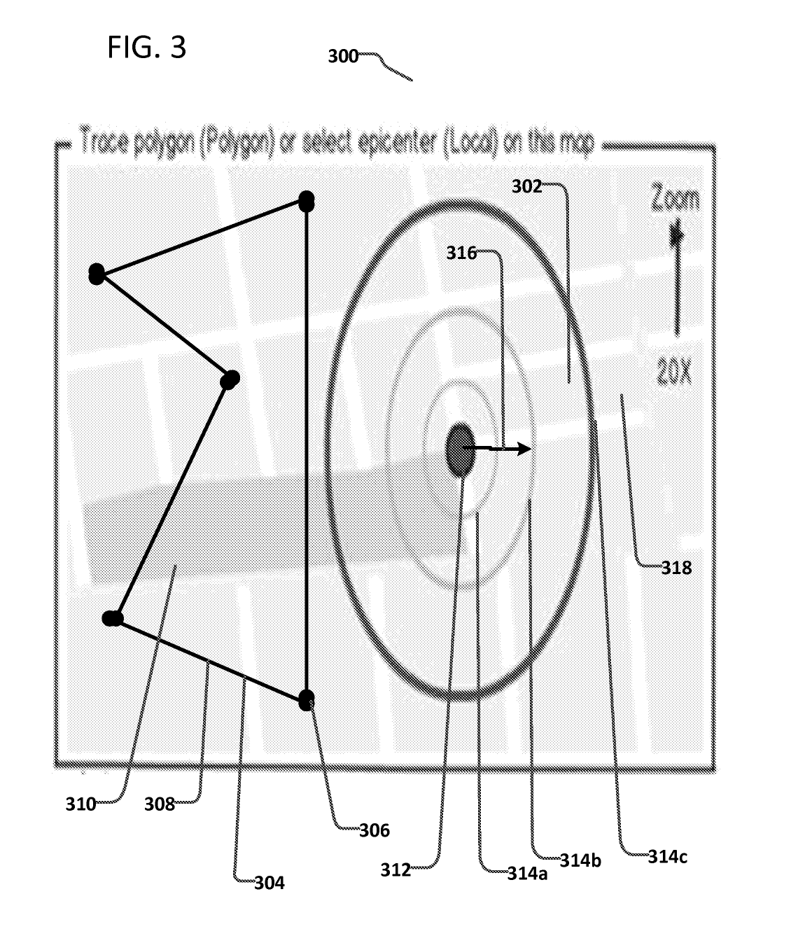

Once the incident has been identified, the incident's geographical area (“IGA”) is defined. This may be done via one or more of several methods, including textual and graphical defining. As contemplated herein, graphical defining may be accomplished via one or more of the approaches as shown in FIG. 3—via a polygon entry or specifying a point (such as the address where the incident occurred) and other information to specify an area (such as a radius to define a circular area). Although generally accomplished by TCC 12, geographical area definition may be set or suggested by an external source that may have identified the incident. By way of example, police may close one or more roads due to winter weather conditions. The police's choice may directly lead to, or be, an IGA, or may be used as the basis for specifying an IGA.

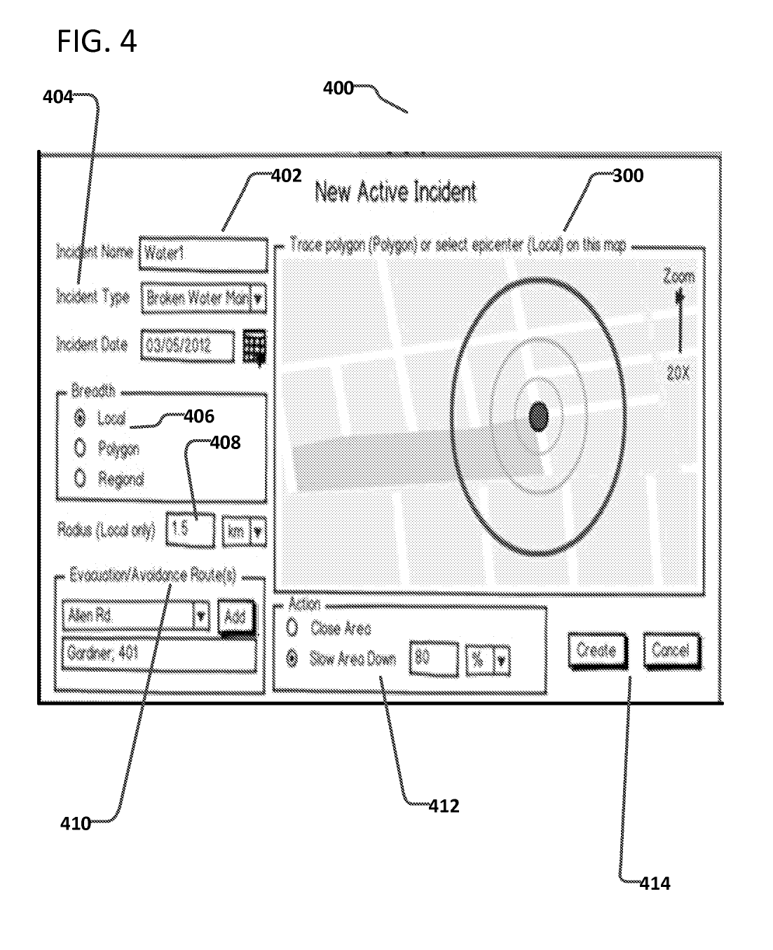

Next at 206 the incident is further defined. This may include providing, obtaining or specifying further information about the incident such as the type of incident (GSD/LE/RE/etc, and possibly subcategories that may be defined or user-definable), incident name, actions to be taken, evacuation routes, and the like (substantially as shown and described in FIG. 4). Importantly, incident module 24a may comprise one or more incident templates, that may be defined by a transit agency, that can auto-populate information about an incident. For example, “broken water main” may be a defined incident type. Such incident type may specify that the IGA should extend to the next intersection coming from the street where the water main has broken, such that all traffic is diverted away from the broken water main. A “gas leak” may be a defined incident specifying a radius inside which people must be removed, with a further radius specifying a larger radius inside which people should be removed.

One example of further definition may be to indicate an allowable speed for vehicles in the IGA. A speed may be defined to a) make sure a vehicle does not travel at an unsafe speed, b) properly disincent a vehicle from taking a street with a low speed limit (for example, if the speed is set very low then transit software 24 will not likely route a vehicle along that street as the resulting trip length will exceed other possible paths), or c) to prevent transit software 24 from allowing a vehicle to travel along that street if the street truly cannot be drive on. One approach to doing this may be as shown in FIG. 4.

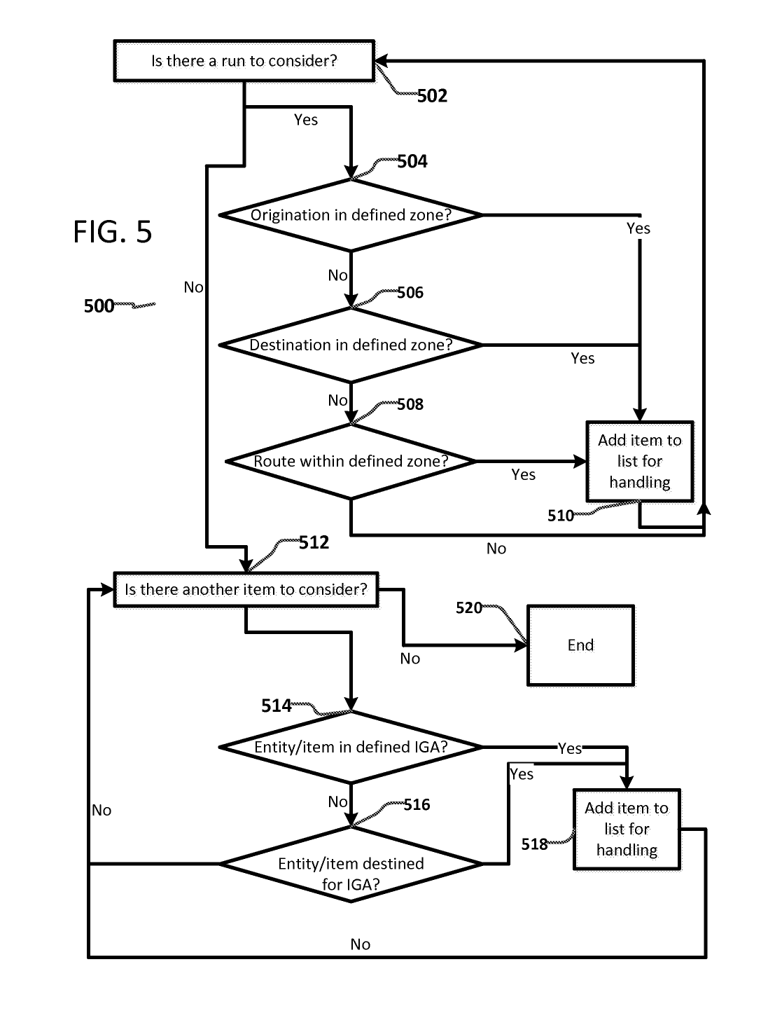

Having described the incident at 206, method 200 begins to identify affected resources at 208. This essentially involves determining any items (assets, transit services, clients, etc) that are within the incident's area, or are going to be. Exemplary identification is described in method 500 of FIG. 5 but may involve obtaining the item's current location, their route's starting point, ending point, or a storage/home location (for example using latitude and longitude) and determining whether any of those locations are within the geographical area defining the incident, as identified in 204. Of course such identification can vary based on, for example, the asset and incident type and alternative identification approaches may be desired.

Having identified the affected items at 208, communication may occur at 210. Such communication may, for example, inform people affected by the incident (riders, drivers, asset managers, the general public, etc) of the incident. The communication may further indicate preparation that the items are to take (such as that people are to pack as they are being picked up and removed from within the incident's geographical area, or what drivers are to do).

At 212 items are secured. Essentially this means that any items that are at risk are removed from risk. This may include, for example, removing riders or other items from within the incident's geographical area, immediately diverting items that are soon to enter the IGA.

Securing items at 212 may involve working or interacting with TCC 12 or transit software 24, such as the scheduling and route planning modules thereof, to prevent any services that involve entering into the IGA (for example where a rider lives within the IGA). In such situations, transit software 24 may communicate with a driver or the rider to determine where they would like to be dropped off (a shelter or an alternative location for example, where such shelter may be selected from a list presented to the rider or driver by transit software 24). Transit software 24 may then create a route (including avoiding the IGA) to secure the item.

Securing items may also involve entering the IGA, with appropriate and as few as possible TIV 14, in an efficient way, to remove riders 20 that are within the IGA.

Securing items at 212, and further activities under 214 may be done according to a single insertion batch scheduling algorithm, for example carried out by scheduling module 24. The single insertion batch scheduling algorithm may be comprised of two main parts: the pre-sorting and the scheduling insertion process. The pre-sorting method essentially takes the set of trips that must be scheduled (such as to secure or otherwise address an item's situation) and sorts them by certain elements selected by the user to approximate the order in which the trips should be done. Exemplary elements may include proximity to the center of the incident, severity of their situation, frailty of the item, and the like. The scheduling insertion process then tries to “string” each event or item's schedule one by one onto the different available runs for a TIV 14 (a run generally being when a vehicle pulls out and goes into operation to when it pulls back in and goes out of operation or is temporarily not in use). The algorithm attempts each possible location on a schedule for a trip before selecting the best place. This best place may be determined as a function of several user defined weights relating to operational characteristics like minimizing time, distance, on board time, etc or maximizing items' safety, for example. The selection of a time and sequence for a particular booking may also depend on constraints for being on time and falling within a certain time window. Of course the single insertion batch scheduling algorithm may be used or combined with other algorithms or routing techniques described herein, such as reducing the speed along a particular segment or street to disincent scheduling module 24 from including such segment or street in a route for TIV 14.

Once items are secured at 212 method 200 may proceed to 214 where affected items' requirements may be completed. Such completion at 214 may be substantially similar to activities performed at 212, but for the fact that at 214 the items are not in particular danger. For example, vehicles and other resources may need to be diverted to perform activities in 212 (for example using vehicles in emergency situations to evacuate rider(s)) and may thus leave other riders or transit services delayed. At 214 such activities may be performed, respecting the rules or requirements relating to the incident.

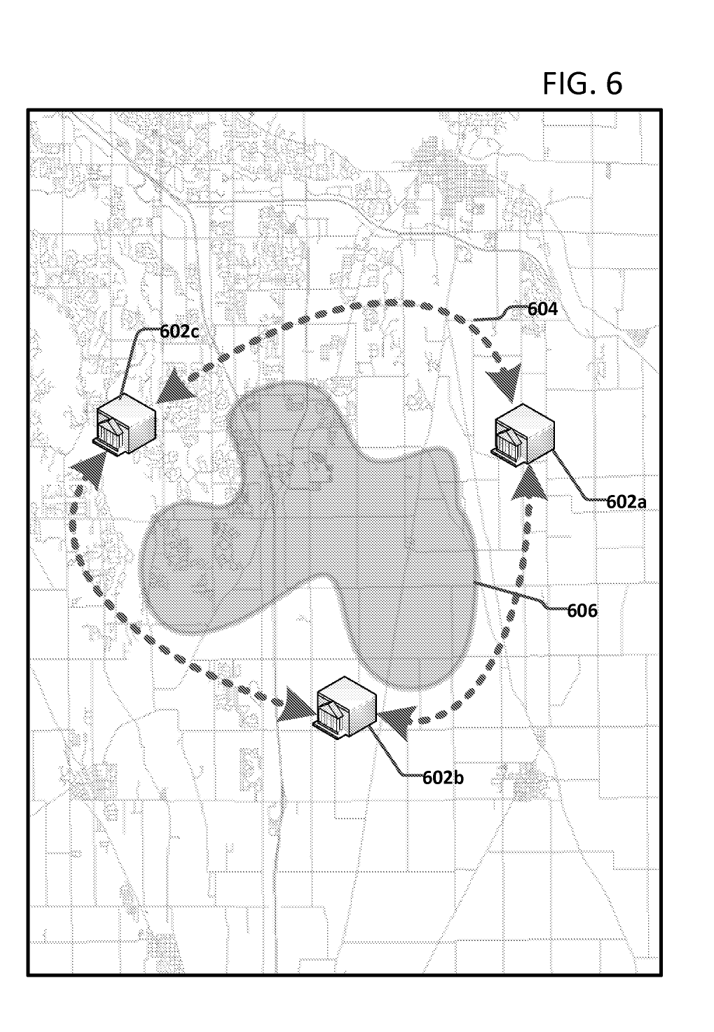

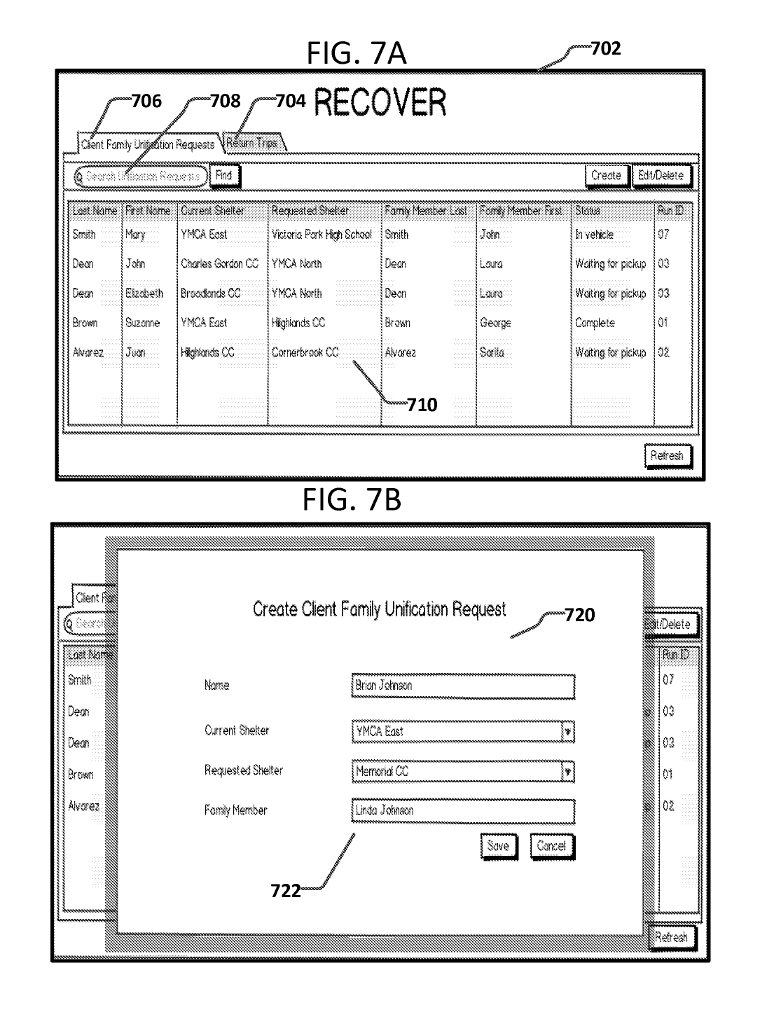

Activities under 214 may also involve transporting items between shelters to deal with an on-going incident (an example of which being described in FIGS. 6 and 7). Activities under 214 may continue substantially until the incident has ended—the leak has been fixed, the water has subsided, etc—and items have been finally returned or resolved.

While activities under 212 may generally be performed as soon as possible after an incident occurs, activities under 214 may be performed later, due to their relatively less urgent nature. In general, activities under 212 may be unscheduled activities, whose costs may be fully attributable to the incident. Activities (and their costs) under 214 may be either fully attributable, partly attributable or not attributable.

It is of course to be understand that all such re-routing, re-assigning of vehicles, and other effects on the transit services or items (including extra driver salaries, damage incurred to items) may be tracked by emergency module 24a as transit software 24 determines such activities are necessary and implements such activities. For example, if TIV 14 is diverted to remove a rider 20 from the IGA, resulting in increased gas and driver salary, before it completes its regularly scheduled run, then such gas and salary are tracked.

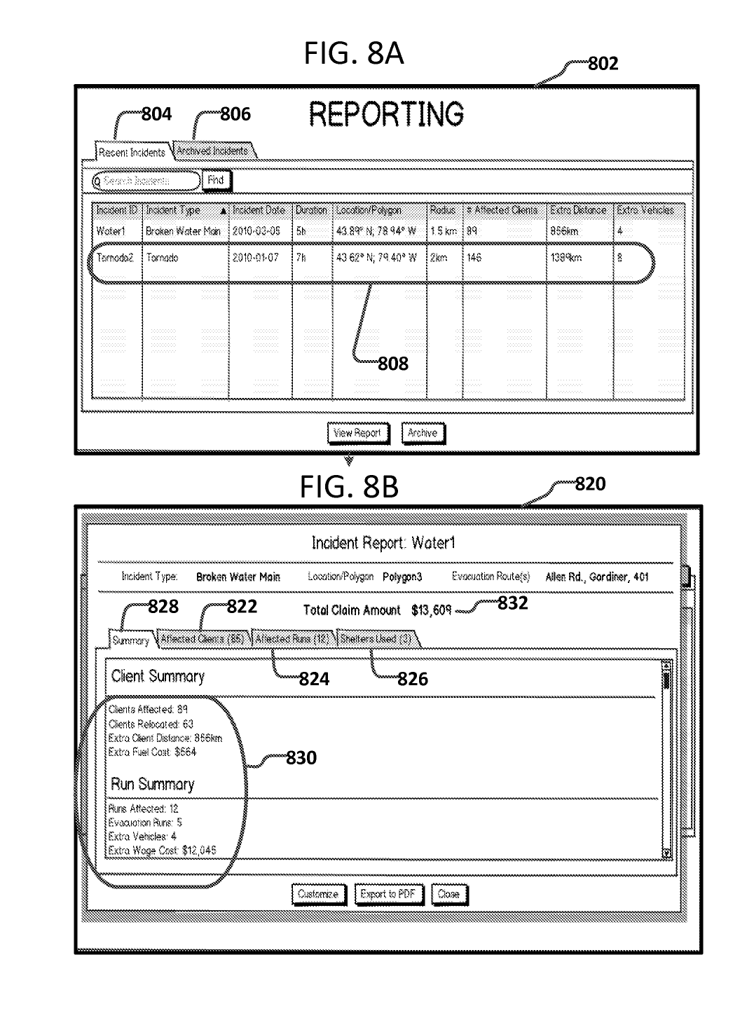

Once the incident has effectively been dealt with method 200 continues to 216. Being dealt with may mean that activities under 212 and 214 have been completed, though activities under 216 need not necessarily wait until all such activities have been completed. Under 216, the costs of handling the incident may be determined, and may include for example, driver salary, fuel, administrative overhead and the like. This may be done by adding all tracked costs (including fully attributable costs, and the appropriate portion of the partially attributable costs) that were caused by the incident. For example, if an item does not have a current schedule (ie it was not, prior to the incident, scheduled to move), then the full costs of the schedule that a scheduling module may create may be included. If, however, an item already has a current schedule (ie it was, prior to the incident, scheduled to move) then only the costs of adjusting the schedule resulting from the incident may be included. Such may allow an agency to submit such costs to receive funding, such as disaster relief funding, and provide an audited trail of how the costs were determined. An exemplary report relating to such costs is shown in FIGS. 8A and 8B. Of course, there may be costs not directly connected to particular new or adjusted schedules (for example schedulers that have to work extra hours, expenses that an agency may have to cover as a result of keeping locations and buildings running longer). These non-route or non-schedule specific costs may also be tracked.

As well, remediation steps may occur at 216. Such remediation steps may include altering the available TIV 14 such as if some were damaged, amending routes if streets are unavailable, returning items to their home locations (such as by specifying that one or more zones, such as districts or neighborhoods set out in software 24 or items of a particular type, such as disabled or unwell, may be returned, or that a particular shelter 602 should be cleared), etc.

FIG. 3 shows a diagram of a screenshot 300 with a map 318 depicting methods of specifying IGAs.

Screenshot 300 comprises IGA 304, further comprising IGA zone 310, polygon point 306 and polygon edge 308. Screenshot 300 further comprises IGA 306, further comprising epicenter 312, IGA zones 314a/b/c and radius 316.

Screenshot 300 may be presented to a user (such as a transit agency employee or operator, on a display of TCC 12 or to rider 20 on RCD 18) by emergency module 24a. Emergency module 24a may allow, provide or facilitate functionality of system 10 and TCC 12, in conjunction with other aspects of system 10. Of course it is to be understood that a user may be directly seated at, and interacting with, TCC 12 or may be accessing emergency module 24a, and viewing screenshot 300, remotely from TCC 12, such as via a mobile or web-based application. Although described as relating to screenshot 300, the above description of how screenshot 300 may operate and be implemented may be substantially similar to other screenshots herein.

IGA 302 may be defined by a user selecting an epicenter 312, such as by clicking on a location on map 318, and specifying one or more radii 316 that may be used to define circles around epicenter 312 that denote one or more IGA zones 314a/b/c. Each radius may represent a level or layer of incident, such that distances further from epicenter 312 may be less of an emergency than those closer, for example.

It is to be understand that the one or more radii 316 are exemplary shape parameters that help define IGA 302. It is to be understood that different shapes (squares, triangles, etc) may be defined using epicenter 312 and one or more shape parameters 316.

Alternatively, IGA 304 may be defined by a user selecting (such as clicking via a mouse or touching a touchscreen) one or more polygon points 306, with each pair being connected by a polygon edge 308. Pairs may be put together by each subsequent selection, of a polygon point 306, by a user being associated with the previous selection, of a polygon point 306, and a polygon edge 308 connecting them. When the first polygon point 306 is selected for the second time the polygon may be completed and the polygon zone 310 may be created.

IGA 302 and 304 may then be viewed graphically, as in FIG. 3, and may also be represented by a set of coordinates. Such coordinates may then allow system 10 (for example TCC 12) to determine whether an item (rider 20, a route, TIV 14) is within, or is going to be within, IGA zone 310 by comparing the item's coordinates to the IGAs coordinates.

It is to be understood that there are many ways to provide geographic parameters (such as polygon points, epicenters, radii, and the like) via a screen such as screen 300. Although not shown, gesture or touchscreen technology, free form clicking and cursor movement, or other approaches to entering information via a screen may be employed. Other options also exist, such as an IGA being set out or defined by another party and then provided to incident module 24a, or subdivisions or areas that are pre-existing in software 24 being an IGA.

FIG. 4 shows a diagram of a screenshot 400 depicting creation of an incident comprising screenshot 300, name 402, type 404, breadth 406, parameter setting 408, evacuation 410, incident action 412 and actions 414.

Screenshot 400 may be used to create an incident and specify properties thereof. A user may input an incident name and type using name 402 and type 404, and specify breadth, such as local, polygon or regional, using breadth 406. A user may further specify an evacuation route (for example if there is flooding, a route that is on higher ground), and one or more incident actions 412. Incident actions 412 may be settings, parameters, or impacts that the incident will have, should have, or could have, on items. For example, incident actions could be a reduction in speed for TIV 14 operating within the IGA, or could be an indicator of how quickly, or by what time, riders 20 need to be removed if they are within the IGA. Finally a user can create or cancel the incident creation using actions 414. Should a user select to create the incident, a new incident object may be created, and can then later be used by TCC 12.

FIG. 5 shows a method 500 of determining which items are affected by an incident. Method 500 is intended to survey all items for which an agency may be responsible, and to determine whether they need to be handled.

Method 500 begins at 502 where a determination is made whether a particular item, for example runs, exists for analysis. Method 500 returns to 502, from 508 or 510, until each such item is considered.

Starting with a particular item (a run that is part of the transit agency's transit services for a particular day, as known by TCC 12, for example), method 500 continues to 504 to determine whether the origination or starting point is in the IGA. This may be, for example, if TIV 14 providing the run is currently in (such as stored in) IGA. If it is, then the item is added to a list of items to be addressed, or is otherwise flagged as “to be addressed”.

Otherwise method 500 continues at 506 to determine whether the destination or ending point is in the IGA. This may be, for example, if TIV 14 providing the run is supposed to end in the IGA (such as stored in, or with its end point). If it is, then the item is added to a list of items to be addressed, or is otherwise flagged as such.

Otherwise method 500 continues at 508 to determine whether the route is in the IGA. This may be, for example, if TIV 14 will be inside the IGA for any portion of any of its routes (a run being made up of one or more routes). If it is, then the item is added to a list of items to be addressed, or is otherwise flagged as such. If it is not then method 500 returns to 502 to determine if there is another route to consider.

Once all items have been considered at 502-512, then method 500 continues to 512 where other items (non-routes) are considered, such as riders 20 and assets (such as TIV 14 or other assets).

At 514 method 500 determines whether the item is within IGA. This may be done in many ways, substantially as described herein. By way of example, an interior point determination method may be used, examples including crossing number or winding number polygon tests, or some form of determining whether the point in question (origination location, etc) is on the same side of each line segment connecting adjacent polygon points (if so, then it is bounded by the various line segments and is inside the polygon). If it is, then the item is added to a list of items to be addressed, or is otherwise flagged as “to be addressed”.

Otherwise method 500 continues at 516 to determine whether the item is destined for the IGA. Again, this may be done in many ways, substantially as described herein. If it is, then the item is added to a list of items to be addressed, or is otherwise flagged as “to be addressed”. Otherwise, method 500 returns to 516.

As soon as there are no more items to consider at 512, method 500 ends, and all items have been considered to determine whether they need to be handled as a result of the incident.

FIG. 6 shows a diagram 600 of possible transportation requirements during an incident, occurring outside the incident's geographical area, comprising one or more shelters 602a/b/c preferably located outside IGA 606, and further comprising one or more routes 604 for travel between shelters 602.

Various TIV 14 may be employed to transfer items (clients, assets, machines, food, etc) between various shelters 602 or return one or more items (such as to their original destination) after the incident has been rectified and/or IGA has been removed or reduced. Routes 604 may be created, for example using transit software 24 as described herein and may be integrated with other routes being performed by TIV 14.

Diagram 600 may be required, or avoided, by software 24 and/or incident module 24a checking shelters 602 for what an item may require before transporting them to that shelter 602. For example, if an item (client) requires a dialysis machine, or TIV 14 needs a battery charger, then only shelters 602 having such machines may be a destination for such client, or else such client may be transferred, as described herein, to a shelter 602 having the required resources, machines, food, etc to accommodate the client.

Each shelter 602 may further have one or more computing devices, that may be similar to RCD 18, that may be used by items (clients, operators, relief workers for example) at shelters 602 to interact with software 24 and obtain information or functionality as described herein. Other relief efforts may also be able to interact with software 24 to allow more, and varied, responders to assist. For example, taxi companies, fire departments, and the like may be able to view open requirements to address items' needs and may be able to fulfill those needs and update software 24. As such, software 24, and incident module 24a in particular, may be a hub or tool for multi-party incident response.

FIG. 7A shows a diagram of a screenshot 700 for monitoring recovery actions during or after an incident. Recovery actions may include “return trips”, visible on return trips tab 704, or “transfer requests” or “item locating”, visible on requests tab 706, which is also generally visible on screenshot 700.

Return trips may include any trip or route that returns an item to its intended location. This may include returning clients to their homes, assets to their storage areas, and the like.

Transfer or transportation requests or item locating may perform one or more of several functions. These may help determine the location of an item (a client, an asset, or the like), or move an item for a particular purpose (TIV 14 may be useful at another location, a family member may want to be unified with another family member at another shelter 602).

Using search box 708 a user, such as a transit agency operator, may enter information to help locate an item. The item may be located and its details displayed, as details of items 710 are displayed. Of course the particular fields are exemplary only but may include item descriptors (names etc), current location, item being sought (family member for example), status (where is the item and/or where is the item being searched for), and an identifier of how the recovery/transfer/unification is to occur (such as a run or route identifier for TIV 14 that will fulfill the request).

Users may also be able to create, edit or delete transfer requests.

FIG. 7B shows a dialog box 720 for creation of transportation requests during an incident. Such transportation requests may include those described with respect to FIG. 6. As shown in FIG. 7B, such transportation request may be a family unification request. Such a request may involve entering data about the request into one or more fields 722, such as the requester (“Name”), Current Shelter, Requested Shelter, and family member to be reunified with (“Family Member”). Saving the request may cause the request to be put into TCC 12 and transit software 24 and/or emergency module 24a in particular, and for transit software 24 to begin attempting to create a run or route for a TIV 14 that can facilitate the request.

FIGS. 8A and 8B shows a diagram of screenshots 802 and 820 for reporting functionality provided by TCC 12 and transit software 24 and/or emergency module 24a.

Reporting functionality allows a transit agency to automatically collect and quantify the impact a particular incident had on their operations, for example for total money that was spent, routes or runs affected, or items affected. Using the methods and systems described herein, the total number of items that are affected by an incident is known. The costs or other factors in securing those items (as in 212 of method 200) and in completing the affected resources' or items' requirements (as in 214 of method 200) is stored and can be grouped.

Screenshot 802 provides an exemplary view of multiple incidents that occurred for a transit agency. Incidents may either be recent incidents and thus shown on recent tab 804 or archived incidents and thus shown on archived tab 806.

Incident summary 808 may show various incident fields that provide information about an incident, such as the ID, type, date, duration, IGA, and some statistics about the items affected (number of clients or vehicles affected, and extra distance traveled). As TCC 12 has all the data relating to the incident, and has calculated or stored a multitude of information relating to the incident, various fields may be shown on screenshot 802.

Screenshot 820 provides an exemplary view of detailed incident information. Such screenshot 820 may display similar items to incident summary 808, on summary tab 828 and summary display information 830, but may allow a user to drill down into more detail about an incident. Such further detail may include overall incident cost 832, listing affected clients on affected clients tab 822 (where each client that was affected is shown, along with how they were affected, such as extra miles traveled or time delay, and the like), affected runs tab 824 (where each run that was affected is shown, along with how each run was affected, such as extra miles traveled or time delay, and the like), or shelters used on shelters used tab 826 (where each shelter that was used is shown, along with how it was used, such as electricity used, number of people housed, and the like).

It is to be understood that the screenshots, methods, and functionality described herein may be implemented on TCC 12 and may be displayed on TCC 12, RCD 18, or any other computing device that an agency may allow to interact with TCC 12. It is further to be understood that the screenshots herein are meant as examples only, and the fields, user interface elements, and workflows suggested are examples only. Many variations thereon are considered within the scope of the present invention.

Computer-executable instructions for implementing the transit software, including incident module 24a and other modules, on a computer system could be provided separately from the computer system, for example, on a computer-readable medium (such as, for example, an optical disk, a hard disk, a USB drive or a media card) or by making them available for downloading over a communications network, such as the Internet.

While the computer system is shown as a single physical computer, it will be appreciated that the computer system can include two or more physical computers in communication with each other. Accordingly, while the embodiment shows the various components of system 10, and TCC 12 residing on the same physical computer, those skilled in the art will appreciate that the components can reside on separate physical computers.

The above-described embodiments are intended to be examples of the present invention and alterations and modifications may be effected thereto, by those of skill in the art, without departing from the scope of the invention that is defined solely by the claims appended hereto.

1. A system for handling an incident affecting a transit agency, the system having an operator from the transit agency, and the transit agency having one or more items, some of the items having a home location, that the transit agency may create a schedule for or have a current schedule for, the current schedule having a starting point, an ending point, and one or more route segments that define portions of streets being traveled on, the system comprising:
a transit control center comprising:
an incident module executed by a computer processor and configured for:
obtaining an indication of the existence of the incident;
defining the incident, comprising receiving one or more geographic parameters relating to the incident and providing an incident geographical area (IGA) relating to the incident;
providing the incident to a scheduling module; and
a scheduling module executed by a computer processor and further comprising a scheduling algorithm stored on a non-transitory computer readable medium for creating schedules for items when executed by the computer processor, the scheduling module configured for:
getting the incident from the incident module; and
determining items affected by the incident, wherein the determining further comprises checking if an item's home location is within the IGA, if an item is currently within the IGA, or if the item's current schedule is to bring them into the IGA.

2. The system of claim 1 wherein the defining the incident further comprises
accepting one or more incident parameters relating to the incident.

3. The system of claim 2 wherein the receiving further comprises presenting a screen to the operator, and the operator entering the one or more geographic parameters via the screen.

4. The system of claim 3 wherein the geographic parameters comprise three or more polygon points, selected by the operator on a map on the screen, and wherein defining further comprises using the three or more points to define a polygon that is the IGA.

5. The system of claim 3 wherein the geographic parameters comprise an epicenter, selected by the operator on a map on the screen, and a radial distance selected by the operator, and wherein the defining further comprises using the point and radial distance to define a circle that is the IGA.

6. (canceled)

7. The system of claim 6 wherein the checking further comprises comparing a home location GPS to the GPS area of the IGA, the current GPS location of the item to the GPS area of the IGA and comparing the GPS locations of the item's current schedule to the GPS area of the IGA.

8. The system of claim 7 wherein the checking further comprises using an interior point determination algorithm.

9. The system of claim 1 wherein the incident module is further configured for securing affected items.

10. The system of claim 9 wherein the securing further comprises:
if an item's home location is within the IGA then confirming if the item is at its home location and creating a current schedule to extract the item from the IGA;
if an item is currently within the IGA, then creating a current schedule to extract the item from the IGA; and
if the item's current schedule is to bring them into the IGA, then adjusting the current schedule to avoid the IGA.

11. The system of claim 10 wherein the securing further comprises using a single insertion batch scheduling algorithm for creating a current schedule or adjusting a current schedule, wherein the single insertion batch scheduling algorithm comprises attempting to string a new schedule for the item onto a set of available runs for a transit industry vehicle of the transit agency, attempting each possible face to string before selecting the place to string.

12. The system of claim 10 wherein the adjusting further comprises:
marking the current schedule for re-scheduling;
reducing one or more allowable speeds on one or more route segments on the current schedule to disincent the scheduling module from selecting such one or more route segments; and
re-scheduling the current schedule according to the scheduling module's scheduling algorithm.

13. The system of claim 10 wherein the creating further comprises:
setting a starting point and ending point;
calculating one or more routes for the starting point and ending point;
reducing one or more allowable speeds on one or more route segments on the current schedule to disincent the scheduling module from selecting such one or more route segments; and
selecting the current route according to the scheduling module's scheduling algorithm.

14. The system of claim 9 wherein the incident module is further configured for calculating a cost to secure each item that is affected.

15. A system for defining an incident affecting a transit system having one or more items and a current schedule for each of the items, the system comprising:
a transit control center comprising:
an incident module executed by a computer processor and comprising one or more incident templates stored on a non-transitory computer readable medium for one or more define incident types that can auto-populate information bout the incident if the incident is of a defined incident type the incident module configured for:
selecting an incident template that can auto-populate information about the incident if the incident is of a defined incident type;
receiving one or more geographic parameters relating to the incident;
defining an incident geographical area (IGA) relating to the incident;
accepting one or more incident parameters relating to the incident.

16. The system of claim 27 wherein the receiving further comprises presenting a screen to the operator, and the operator entering the one or more geographic parameters via the screen.

17. The system of claim 16 wherein the geographic parameters comprise three or more polygon points, selected by the operator on a map on the screen, and wherein defining further comprises using the three or more points to define a polygon that is the IGA.

18. The system of claim 16 wherein the geographic parameters comprise an epicenter, selected by the operator on a map on the screen, and a radial distance selected by the operator, and wherein the defining further comprises using the point and radial distance to define a circle that is the IGA.

19. The system of claim 15 wherein the accepting further comprises presenting a screen to the operator, and the operator entering the incident parameters via the screen.

20. (canceled)

21. A system for quantifying the impacts of an incident affecting a transit agency, an incident having a geographical area (IGA) relating to the incident, the system having an operator from the transit agency, and the transit agency having one or more items, some of the items having a home location, that the transit agency may create a schedule for or have a current schedule for, the current schedule having a starting point, an ending point, and one or more route segments that define portions of streets being traveled on, the system comprising:
a transit control center comprising:
a scheduling module executed by a computer processor and further comprising a scheduling algorithm stored on a non-transitory computer readable medium and executed by said computer processor for creating schedules for items, the scheduling module configured for:
getting the incident;
determining items affected by the incident, wherein the determining further comprises checking if an item's home location is within the IGA, if an item is currently within the IGA, or if the item's current schedule is to bring them into the IGA;
securing items affected by the incident;
computing a cost to secure items affected by the incident; and
calculating the impact of the incident.

22. (canceled)

23. The system of claim 21 wherein the securing further comprises:
if an item's home location is within the IGA then confirming if the item is at its home location and creating a current schedule to extract the item from the IGA;
if an item is currently within the IGA, then creating a current schedule to extract the item from the IGA; and
if the item's current schedule is to bring the item into the IGA, then adjusting the current schedule to avoid the IGA.

24. The system of claim 23 wherein the computing further comprises:
for each item that requires a current schedule to extract the item from the IGA, computing the cost of the schedule; and
for each item that requires a current schedule to be adjusted, computing the cost of the adjustment to the current schedule.

25. The system of claim 24 where the cost of the adjustment and the cost of the schedule further comprises driver salary and fuel.

26. The system of claim 21 where the calculating further comprises summing all computed costs and one or more non-route costs relating to the incident.

27. The system of claim 15 wherein one of the incident parameters is a category and wherein the category is one of: a general service disruption which may significantly affect regular operation of transit, making the IGA either temporarily unusable or severely compromised, a localized emergency requiring evacuation or avoidance from the IGA to elsewhere within the service area or a regional emergency which affect the IGA and the entire service area.

28. The system of claim 2 wherein one of the incident parameters is a category and wherein the category is one of: a general service disruption which may significantly affect regular operation of transit, making the IGA either temporarily unusable or severely compromised, a localized emergency requiring evacuation or avoidance from the IGA to elsewhere within the service area or a regional emergency which affect the IGA and the entire service area.
